(19) United States
(12) Patent Application Publication
(10) Pub. No.: US 2024/0060196 A1
(43) Pub. Date: Feb. 22, 2024

(54) SYSTEM AND PROCESS FOR ENRICHING LITHIUM FROM SEAWATER

(71) Applicant: KING ABDULLAH UNIVERSITY OF SCIENCE AND TECHNOLOGY, Thuwal (SA)

(72) Inventors: Zhiping LAI, Thuwal (SA); Zhen LI, Thuwal (SA); Kuo-Wei HUANG, Thuwal (SA)

(21) Appl. No.: 18/269,354

(22) PCT Filed: Jan. 18, 2022
(86) PCT No.: PCT/IB2022/050405

§ 371 Date: Jun. 23, 2023

Related U.S. Application Data
(60) Provisional application No. 63/251,340, filed on Oct. 1, 2021.
(60) Provisional application No. 63/139,006, filed on Jan. 19, 2021.

(51) Int. Cl. C25B 1/46; C25B 9/21; C25B 11/031; C25B 13/07

(52) U.S. Cl. CPC C25B 1/46; C25B 9/21; C25B 11/031; C25B 13/07

(57) ABSTRACT

A cell for enhancing a lithium (Li) concentration in a stream includes a housing; a dense lithium selective membrane located in the housing and dividing the housing into a first compartment and a second compartment; a cathode electrode located in the first compartment; an anode electrode located in the second compartment; a first piping circuit fluidly connected to the second compartment and configured to supply a feed stream to the second compartment; a second piping circuit fluidly connected to the first compartment and configured to circulate an enrichment stream through the first compartment; and a power source configured to apply a voltage between the cathode electrode and the anode electrode to initiate an oxidative electrochemical reaction on the anode electrode and a reductive electrochemical reaction on the cathode electrode. The dense lithium selective membrane has a thickness less than 400 μm.

### CROSS-REFERENCE TO RELATED APPLICATIONS

This application claims priority to U.S. Provisional Patent Application No. 63/139,006, filed on Jan. 19, 2021, entitled “PROCESSES FOR ENRICHING LITHIUM FROM SEAWATER,” and U.S. Provisional Patent Application No. 63/251,340, filed on Oct. 1, 2021, entitled “SYSTEM AND PROCESS FOR ENRICHING LITHIUM FROM SEAWATER,” the disclosures of which are incorporated herein by reference in their entirety.

### BACKGROUND

### Technical Field

Embodiments of the subject matter disclosed herein generally relate to a system and method for enriching lithium (Li) from seawater, and more particularly, to a process that enriches a stream with lithium ions from seawater and simultaneously prevents other ions present in the seawater to enter the enriched stream, through a continuous electrical pumping membrane (CEPM) process that uses a glass-type dense membrane.

### Discussion of the Background

Lithium is quickly emerging as a strategically important commodity due to the rapid growth in demand for lithium batteries. The commercial lithium is mainly produced from land resources such as salt-lake brines and high-grade ores using a chemical precipitation process, which is technically and economically feasible only when the lithium concentration in the brine or ore is in the hundreds of part-per-million (ppm) level. However, the lithium reserve on land is limited and geographically unevenly distributed. The global lithium demand in 2018 was 0.28 Mtons (Li₂CO₃ equivalent). This demand is expected to increase to about 1.4-1.7 Mtons (Li₂CO₃ equivalent) by 2030. The Li reserve on land is expected to be exhausted by 2080.

The oceans contain 5,000 times more lithium than the land. It provides almost unlimited and location-independent lithium supplies. However, extraction of lithium from seawater is extremely challenging because of its low concentration (about 0.2 ppm) and the more than 13,000 ppm opposed ions (sodium, magnesium ion, calcium ion, potassium ion, etc.). To date, there is no known system and associated process that efficiently can extract the Li atoms from such low concentration seawater. In this regard, U.S. Pat. No. 6,764,584 B2 [1], the content of which is incorporated herein by reference in its entirety, discloses a two-step process to produce lithium concentrate from brine or seawater. The first step used an adsorption process to enrich the lithium to the level of 1,200 — 1,500 ppm, and the second step engaged a two-stage electrodialysis in series, to increase the lithium concentration to about 1.5%. U.S. Pat. No. 4,636,295, [2] the content of which is also incorporated herein by reference in its entirety, developed an electrodialysis method for the recovery of lithium from brines. The method includes an anode compartment and a cathode compartment separated by a multiplicity of alternating monopolar cationic permselective membranes and monopolar anionic permselective membranes. Electricity in the range of about 10 to 500 A/m² was applied to drive the lithium ions from the anode compartment to the cathode compartment. However, the method worked only when the lithium concentration was higher than 30 ppm and thus, this process and system cannot be applied to seawater based Li brine. U.S. Pat. No. 9,932,653 B2, [3] the content of which is also incorporated herein by reference in its entirety, describes an electrical recovery process which also used a lithium selective membrane to recover lithium from the feed stream to the recovery stream. Mesh-like electrodes were directly attached to both sides of the membrane with the anode facing the recovery stream. The process primarily relies on the concentration gradience to drive lithium ions across the membrane. Hence, the process is slow, and the lithium concentration in the recovery stream is lower than that of the feed stream. U.S. Pat. No. 10,689,766 B2, [4] the content of which is also incorporated herein by reference in its entirety, improved this electrical recovery process by applying a lithium adsorption layer to the feed side of the lithium selective membrane. The process enhanced the production rate, but did not disclose how to enrich lithium from the feed stream.

The lithium concentration is arguably the most important factor that determines the technical challenges of lithium extraction. When the lithium concentration in the brine is high enough, the lithium ions can be easily harvested by the conventional chemical precipitation method. As the lithium concentration in seawater is extremely low (about 0.2 ppm), it is highly desirable to develop a process to enrich the lithium concentration in the brine before being able to use the traditional lithium extraction methods. In addition, the energy consumption of the enrichment process should be sufficiently low to make the process economically viable, which is not the case for the technologies discussed above.

Thus, there is a need for a new system that is capable of selectively enriching lithium from low concentration and also using a low amount of energy in the enriching process.

### BRIEF SUMMARY OF THE INVENTION

According to an embodiment, there is a cell for enhancing a lithium (Li) concentration in a stream, and the cell includes a housing, a dense lithium selective membrane located in the housing and dividing the housing into a first compartment and a second compartment, a cathode electrode located in the first compartment, an anode electrode located in the second compartment, a first piping circuit fluidly connected to the second compartment and configured to supply a feed stream to the second compartment, a second piping circuit fluidly connected to the first compartment and configured to circulate an enrichment stream through the first compartment, and a power source configured to apply a voltage between the cathode electrode and the anode electrode to initiate an oxidative electrochemical reaction on the anode electrode and a reductive electrochemical reaction on the cathode electrode. The dense lithium selective membrane has a thickness less than 400 μm.

According to another embodiment, there is a multi-stage cell for enhancing a lithium (Li) concentration in a stream, and the multi-stage cell includes plural cells connected in series to each other. Each cell has the structure described in the above paragraph. The enrichment stream from a previous cell is the feed stream of a current cell.

According to yet another embodiment, there is a method for enhancing a lithium (Li) concentration in a cell, and the method includes a step of placing a dense lithium selective membrane in a housing to divide the housing into a first compartment and a second compartment, a step of supplying a feed stream to the second compartment, wherein the feed stream includes seawater, a step of supplying an enrichment stream to the first compartment, a step of applying a voltage between a cathode electrode, which is located in the first compartment, and an anode electrode, which is located in the second compartment, to initiate an oxidative electrochemical reaction on the anode electrode and a reductive electrochemical reaction on the cathode electrode, and a step of driving the Li atoms from the seawater into the enrichment feed, through the dense lithium selective membrane. The dense, lithium selective membrane has a thickness less than 400 μm.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a cell for enhancing a lithium concentration in a stream by driving lithium ions from seawater through a dense lithium selective membrane;

FIG. 2 illustrates the chemical configuration of the dense lithium selective membrane;

FIG. 3 illustrates the migration of the Li ions through the dense lithium selective membrane;

FIG. 4 is a schematic diagram of another cell for enhancing a lithium concentration in a stream by driving lithium ions from seawater through the dense lithium selective membrane;

FIG. 5 is a schematic diagram of still another cell for enhancing a lithium concentration in a stream by driving lithium ions from seawater through the dense lithium selective membrane;

FIG. 6 is a schematic diagram of yet another cell for enhancing a lithium concentration in a stream by driving lithium ions from seawater through the dense lithium selective membrane;

FIG. 7 is a schematic diagram of a multi-stage cell that includes

plural cells connected in series;

FIG. 8 is a flow chart of a method for enhancing the lithium in a stream from seawater;

FIGS. 9A and 9B show electronic microscopy images of the dense lithium selective membrane;

FIG. 10 illustrates the chemical analysis of the dense lithium selective membrane;

FIGS. 11A and 11 B illustrate the physical structure of copper hollow fibers used with the cell;

FIG. 12 is a table that illustrates the concentration of lithium ions and other major ions at different stages in the multi-stage cell of FIG. 7;

FIG. 13 shows chronoamperometric curves at each stage; integrating the area under the curve gives the total charge passing through the membrane in Coulombs for each stage;

FIG. 14 illustrates the steady-state current vs. the lithium feed concentration at different stages of the process;

FIG. 15 illustrates the contributed faradaic efficiencies of the different ions for each stage;

FIG. 16 illustrates the X-ray diffraction pattern of the collected lithium product powder, the theoretically standard XRD pattern; and

FIG. 17 is a flow chart of a method for enhancing the lithium in a stream from seawater.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a lithium enrichment process that uses as a feed seawater having a very low concentration of lithium, in the parts-per-billion (ppb) range. However, the embodiments to be discussed next are not limited to only such a low-concentration lithium seawater, but they may be used for any brine having the lithium with a ppm concentration.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a continuous electrical pumping membrane (CEPM) process is introduced and a system in which the CEPM process is implemented includes a first compartment separated from a second compartment by a lithium selective membrane. The lithium selective membrane is defined herein to be any membrane that allows Li atoms to pass at least 10 times faster than each of Mg atoms and Na atoms. The enrichment process includes a step of selecting the lithium selective membrane to be a dense (which is defined herein as a material that is impermeable to water and gas) membrane, for example, a LiₓLa_{2/3-x/3}TiO₃ (LLTO) membrane, with x ranging from 0.23 to 0.67, which is prepared from LLTO nanoparticles using a high-temperature sintering process, but other materials may also be used as discussed later, and this membrane is referred herein as a glass-type dense lithium selective membrane, a step of introducing the initial enrichment stream to the first compartment and the feed stream to the second compartment, an optional step of tuning the pH of the enrichment stream in the range between 4.5 and 7.0 by addition of acids or acidic gases, a step of connecting the cathode electrode to the first compartment and the anode electrode to the second compartment, a step of applying a voltage high enough to trigger an oxidative electrochemical reaction on the anode and a reductive electrochemical reaction on the cathode, a step of driving lithium ions from the feed stream, through the lithium selective membrane, to enrich the enrichment stream while the transport of other ions present in seawater is substantially blocked by the lithium selective membrane (for example, the glass-type dense LLTO membrane). In addition, the method may include a Pt-Ru coated copper hollow fibers used as the cathode electrode or in addition to the cathode electrode. In one application, CO₂ is introduced from an inner channel of the copper hollow fibers, blown out through the porous wall of the fibers, and ultimately released uniformly into the first compartment. The typical redox electrochemical reactions taking place in the cell supporting this method involve hydrogen reduction and chlorine oxidation. In this scenario, hydrogen and chlorine gases are released from the cathode and anode, respectively, and collected as valuable by-products. In one application, the lithium selective membrane may be a glass-type membrane. The term “glass-type” is defined to be a material that has no or low-density grain boundaries in its microstructure. In one application, the low-density is defined as being equal to or less than 10%, except 0%. The glass-type material typically has a transparent or semi-transparent appearance when illuminated with visible light. However, the glass-type material may also include a material that is opaque to visible light. In one embodiment, the lithium selective membrane includes a ceramic material. In another embodiment, the lithium selective membrane is a hybrid-based membrane, i.e., includes organic and non-organic materials.

The process may be further improved by creating a third compartment to fully accommodate the anode electrode, i.e., remove it from the second compartment. The third compartment is separated from the second compartment by an anion exchange membrane and it is filled with saturated NaCl solution to facilitate the release of chlorine gas as a valuable by-product. The process may also be improved by using other redox electrochemical reactions to drive the enriching process, for example, the redox pair Fe²⁺/Fe³⁺. In this case, a fourth compartment is generated to fully house the cathode electrode. The fourth compartment is separated from the first compartment by an anion exchange membrane and filled with the oxidant solution of the redox pair, i.e., Fe³⁺ of the redox pair Fe²⁺/Fe³⁺. The anode electrode is placed in the third compartment, and the reductant solution of the redox pair, i.e., Fe²⁺ of the redox pair Fe²⁺/Fe³⁺, as the anode stream. The redox pair may also include Cl⁻/ClO₃_{^{−}}, I⁻/I₂, Ag/AgCl, Hg/Hg₂Cl₂, hydroquinone/1,4-benzoquinone etc.

In one application, a multi-stage cell may be configured to stack the membrane units of plural cells to form a cascade system to enrich lithium to a higher level. In this cascade system, the enriched stream from the previous stage is used as the feed stream in the current stage. Lithium is extracted from the enriched stream of the final stage by the conventional chemical precipitation method.

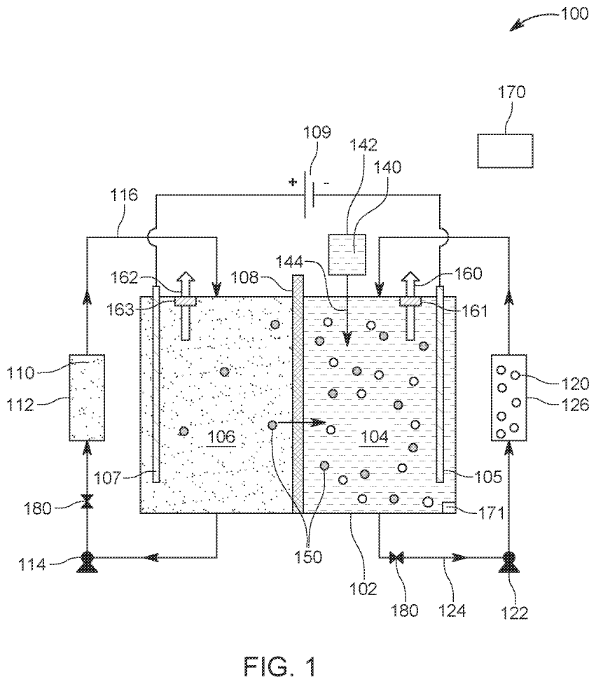

A lithium enhancing cell and associated method are now discussed in more detail with regard to the figures. FIG. 1 shows a cell 100 that supports the CEPM process, and the cell 100 is an electrical cell that has a housing 102 that hosts a first compartment 104, which is separated from a second compartment 106 by a dense, lithium selective membrane 108 (called herein, for simplicity, a lithium selective membrane). The lithium selective membrane 108 can be made not only from LLTO, but from other superionic conductors including but not limited to NASICON (Li_{1+x+y}AlₓM₂₋ₓSi_{y}P_{3-y}O₁₂, M=Ti, Ge, 0≤x≤0.6, 0≤y≤0.6), Li₁₁₋ₓM₂₋ₓP₁₊ₓS₁₂ (M=Ge, Sn, Si), and Li_{x/3}M_{2z/3-x/3-4y/3}N_{y}O_{z} (M=Tetravalent metal ion and N=trivalent metal ion, 0≤x≤1.0, 0≤y≤1.0, 2.9≤z≤3.0). The lithium selective membrane can be constructed in different forms. It can be sintered from nanoparticles at high temperature to form a dense, glass-type (this is an optional feature), thin film, where a thickness of the film is less than 400 micrometers. The nanoparticles can also be embedded into polymer or inorganic binders to form mixed matrix membranes.

An anode electrode 107 is placed in the second compartment 106 and a cathode electrode 105 is placed in the first compartment 104. The two electrodes are connected to a power source 109 (e.g., direct current source) with the anode connected to the positive side of the power source. A feed stream 110, which may be stored in a feed reservoir 112, is pumped with a pump 114 into the second compartment 106, along a close piping circuit 116. Note that the feed reservoir 112 may be the ocean or a lake or any natural body of water that contains the lithium diluted in a brine, and the pump 114 is optional. The enrichment stream 120 is also optionally circulated in the first compartment 104 by a pump 122, through a piping circuit 124. The enrichment stream 120 may be held in an enrichment reservoir 126. The volume of the feed stream 110 is typically much larger than that of the enrichment stream 120. An acid 140, stored in an acid reservoir 142, may be supplied to the first compartment 104, through a port 144, to render the enrichment stream 120 acidic. The acid 140 may be a polyprotic or weak acid including phosphoric acid, carboxylic acid, acetic acid, citric acid, and glycine, etc., which is used to form a buffer solution to stabilize the pH of the enrichment stream 120 in the range preferably between 4.5 and 7.0 during the entire enriching process.

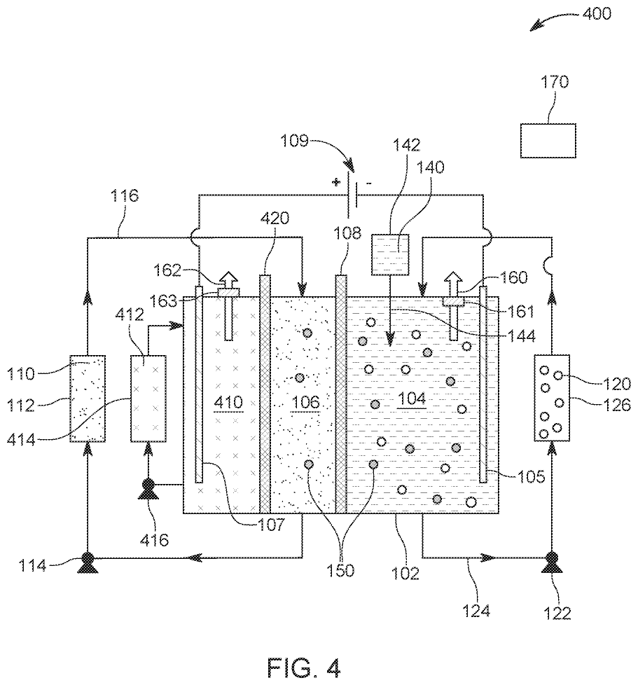

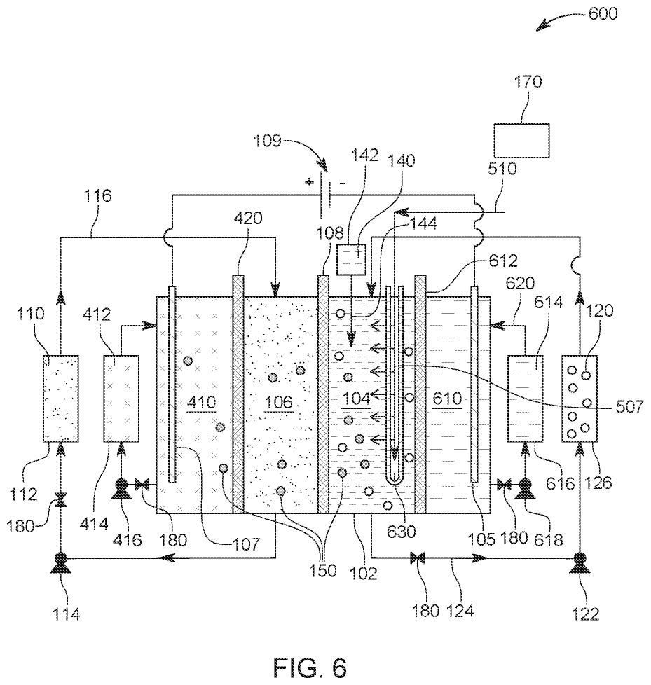

The feed stream 110 is a lithium 150 containing solution that is needed to enrich the lithium concentration in the enrichment stream. It includes seawater and/or brine solutions. The enrichment stream 120 is the solution that receives the lithium ions 150 from the feed stream 110. An anode stream, which is discussed later with regard to FIG. 4, is the solution in which the anode electrode 107 is placed when the anode electrode is separated from the feed stream. A cathode stream, which is discussed later with regard to FIG. 6, is the solution in which the cathode electrode 106 is placed when the cathode is separated from the enrichment stream. The initial concentration of the enrichment solution 120 can be less, equal or higher than that of the feed stream 110, but after the enrichment process, the enrichment solution 120 has a higher lithium concentration than the feed stream 110.

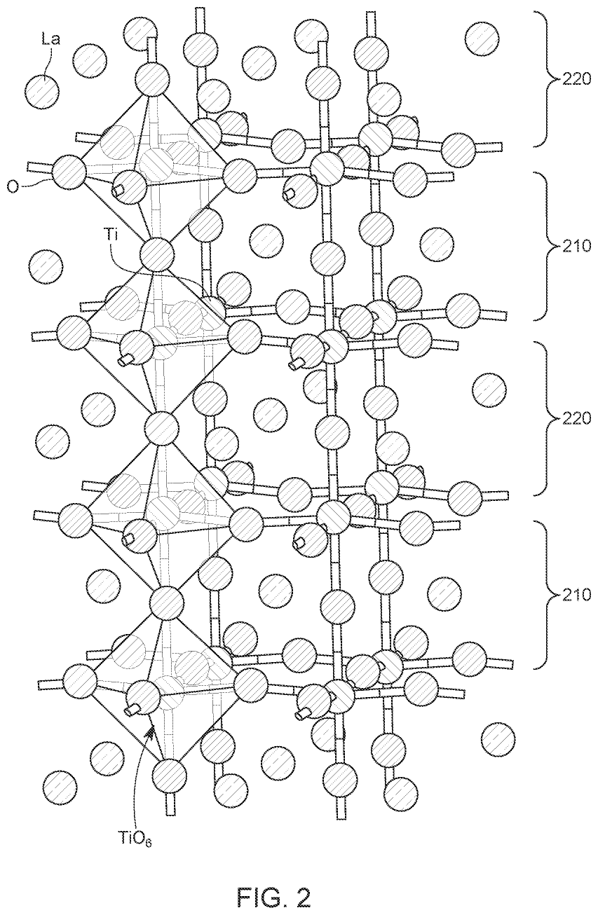

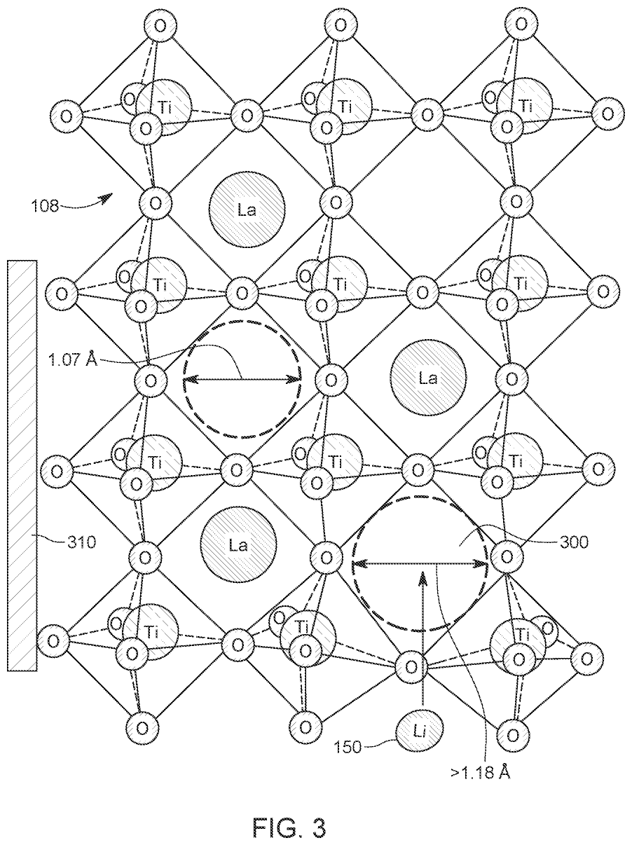

The lithium selective membrane 108 of the present embodiment is a ceramic-based, solid-state, lithium conducting electrolyte, preferably, made of LiₓLa_{2/3-x/3}TiO₃ (LLTO). When the LLTO membrane is made to be (optionally, glass-type) dense, it allows the Li⁺ ions to migrate through its perovskite-type lattice, but blocks the transport of all other major ions present in seawater (i.e., Na⁺, K⁺, Mg²⁺, Ca²⁺, etc.) due to their larger ionic sizes and/or incompatible valence states. The crystal structure of LLTO 108 is shown in FIG. 2, where the TiO₆ octahedra is shown to be extending between a La-poor layer 210 and a La-rich layer 220, where the layer 220 has more La atoms than the layer 210. When this structure is exposed to the Li ions, as shown in FIG. 3, the Li ions 150 migrate through the intra lattice space 300 of LLTO 108 as an average diameter of the intra lattice space 300 is comparable or slightly larger than the size of the Li ions. In one application, the glass-type dense LLTO membrane is coated with a protective layer 310, which is made from a cation exchange resin, preferably Nafion®, on the outside surface, to protect it from corrosion. The protective layer to the lithium selective membrane can be prepared from other anion exchange resins, including but not limited to DOWEX Marathon®, Aldex®, LEWATIT®, SACMP®, Tulsion®.

The LLTO is one of the superior solid-state lithium ion super-conductors. Its high lithium ion conductivity and high selectivity to other ions can be explained from its crystal structure. The LLTO has a perovskite-type crystal structure as illustrated in FIG. 2. The lattice framework of the LLTO consists of interconnected TiO₆ octahedra forming cubic cages or pores that accommodate Li⁺ and La³⁺. The large La³⁺ ions act as support pillars to stabilize the crystal structure. The high valency of La³⁺ causes an alternative arrangement of the La-rich layers 220 and La-poor layers 210 along the c-axis, and generates abundant vacancies 300 in the lattice that allow intercalation of L⁺The transport of Li⁺ from one cage to the others needs to pass through a square window or intra lattice space 300 having a size of 0.75 to about 1.5 Å, e.g., 1.07 Å, which is defined by the four neighbouring TiO₆ tetrahedra, as shown in FIG. 3. The size of the Li⁺ (1.18 Å) is slightly bigger than the size of the window 300, which requires a slight distortion in the LLTO framework to enlarge the windows and this is possible due to the thermal vibrations of the TiO₆ octahedra. Other ions present in the seawater feed (i.e., Na⁺, K⁺, Mg²⁺, Ca²⁺, etc.) are much larger than the lithium ion, which requires a substantial larger distortion and thus a much higher energy barrier to transport them. Hence, from these properties of the LLTO membrane it is expected that the LLTO membrane will allow fast transport of Li⁺ but blocks all other major ions present in seawater. In addition, the thickness of the membrane 108, which is discussed later, contributes to enhancing the Li⁺ ions migration and blocking the other ions.

Inert electrodes made of carbon cloth, graphite, titanium, etc. with optional noble metal coating (Pt, Ru, Ir, etc.) may be used for the anode 107 and cathode 105. During the CEPM process, a voltage higher than 1.75 V is applied by the power source 109 to the electrodes, which triggers the following electrochemical reactions at the cathode and anode.

At the cathode, the following chemical reaction takes place:

$${H}^{+} + {e}^{-} \to \frac{1}{2} {H}_{2} ↑ \qquad ( 1 )$$

while at the anode the following reaction takes place:

$${Cl}^{-} - {e}^{-} \to \frac{1}{2} {Cl}_{2} ↑ . \qquad ( 2 )$$

The hydrogen gas 160 is continuously produced from the cathode 105 through reaction (1), thereby driving the transport of lithium 150 from the feed stream 110, through the LLTO membrane 108, to be enriched in the enrichment stream 120. Simultaneously, chlorine 162 is generated from the anode 107. However, in this case the chlorine 162 may dissolve partially or completely in the feed stream 110 for this embodiment. FIG. 1 shows the cell 100 having corresponding ports 161 and 163 for the hydrogen and chlorine gases 160 and 162, respectively. A controller 170, e.g., a processor, a laptop, any computing device, may be provided to coordinate all the pumps to control the flow of each stream through the cell. Corresponding valves 180 may be provided along the piping systems 116 and 124 to refresh the feed stream 110 and/or to extract the enriched stream 120 to further process it to extract the Li atoms.

To avoid the dissolution of the chlorine 162 in the feed stream 110, in one embodiment as illustrated in FIG. 4, a third compartment 410 is formed within the second compartment, and the third compartment 140 is separated from the second compartment 106 by an anion exchange membrane 420, which allows primarily the transport of anions rather than cations. The anion exchange membrane may include but not limited to Neosepta®, Sustainion®, Fumasep®, Tokuyama© A series, AEMION™, and Fujifilm© ion membranes.

The anode electrode 107 is now fully located within the third compartment 410 in this embodiment. A saturated NaCl solution is used as the anode stream 412, which is loaded into a reservoir 414 and optionally circulated with a pump 416 through the third compartment 410. As the chlorine 162 has a much lower solubility in the saturated NaCl solution 412, most of it will be released as chlorine gas and collected as a valuable side product at port 163.

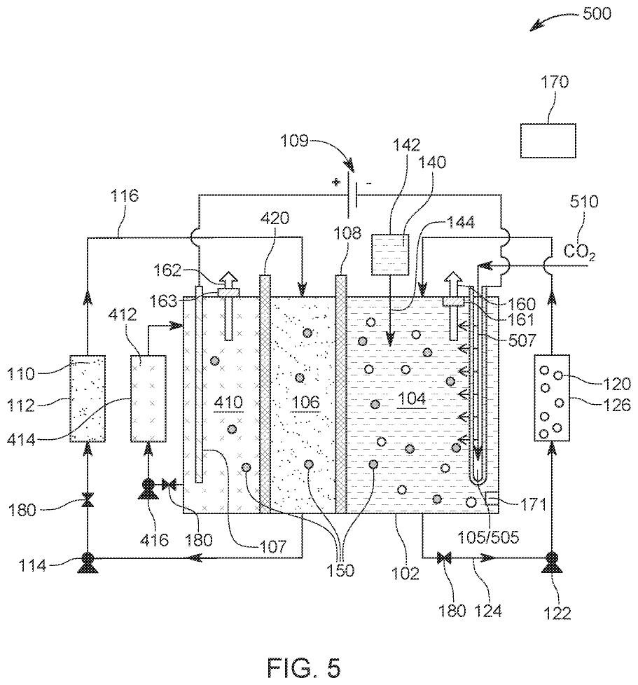

In another embodiment as illustrated in FIG. 5, the cell 500 has the cathode 105 implemented as a copper hollow fiber cathode 505. The copper hollow fiber cathode 505 may coated with one or more noble metals such as Pt-Ru (2.0 mg cm⁻²) to facilitate the hydrogen-evolution reaction. The copper hollow fiber has a standard finger-like porous structure, which allows CO₂ gas 510 to be introduced from outside the cell into an inner channel 507 defined within the cathode 505, and the CO₂ is blown out through the porous wall of the cathode 505, to ultimately be released uniformly into the enrichment stream 120 within the first compartment 104. The released CO₂ 510 creates an acidic environment near the cathode 505, which enhances the Faradaic efficiency at high current densities. The acid 140 can still be used as an auxiliary solution to control the pH of the feed stream, whereby the CO2 gas 510 and the acid 140 form a buffer solution to maintain the pH of the enrichment stream 120 between 4.5 and 7.0 to protect the LLTO membrane 108 from alkaline corrosion.

When blowing the CO₂ gas 510 through the copper hollow fiber cathode 505, the electrochemical reactions at the cathode 505 change as follows:

$${CO}_{2} + {H}_{2} O + {e}^{-} \to {HCO}_{3}^{-} + \frac{1}{2} {H}_{2} ↑ \qquad ( 3 )$$

$${H}_{3} {PO}_{4} + {HCO}_{3}^{-} \to x {H}_{2} {PO}_{4}^{-} + 2 ( 1 - x ) {HPO}_{4}^{2 -} + {H}_{2} {CO}_{3} \qquad ( 4 a )$$

$${H}_{2} {PO}_{4}^{-} + {e}^{-} \to {HPO}_{4}^{2 -} + \frac{1}{2} {H}_{2} ↑ \qquad ( 4 b )$$

The electrochemical reaction at the anode 107 will be the same as described by reaction (2). The produced hydrogen either through reaction (1) or through reaction (3) and reaction (4b) are collected as a valuable side product as previously discussed.

In another embodiment as illustrated in FIG. 6, the cell 600 is configured to use other redox electrochemical reactions to drive the enriching process. One example is to use the redox pair Fe²⁺/Fe³⁺. In this case, a fourth compartment 610 is formed within the first compartment, and the fourth compartment is separated from the first compartment 104 by using an anion exchange membrane 612. In this way, the fourth compartment fully houses the cathode electrode 105. A Fe³⁺ solution is employed as the cathode stream 614, which is loaded into a reservoir 616 and optionally circulated with a pump 618, through a piping circuit 620, in the fourth compartment 610. The anode electrode 107 is still inserted into the third compartment 410, but the anode stream 412 is replaced in this embodiment by a Fe²⁺ solution. The auxiliary electrolyte 140 and/or auxiliary gas 510 are optionally added to the enrichment stream 120 in this embodiment to improve its conductivity. A gas distributor 630, which may have the same structure as the cathode 505 but the gas distributor is not electrically connected to the power source 109, may be optionally employed to blow the auxiliary gas 510 into the first compartment 104. A voltage higher than 0.8 V is applied by the power source 109 to the electrical cell 102, which triggers the following electrochemical reactions at the cathode:

Fe³⁺+e⁻→Fe²⁺ (7)

and at the anode

Fe²⁺−e⁻→Fe³⁺. (8)

The auxiliary electrolyte 140 may include LiCl, NaCl, acetic acid, etc., and the auxiliary gas 510 may also include SO₂, Cl₂ and NH₃, etc.

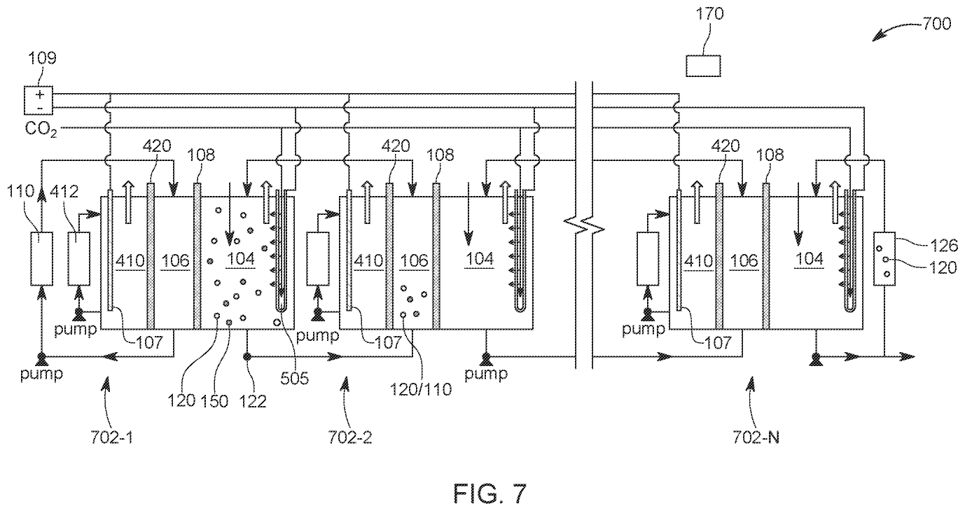

The cells 100 to 600 discussed herein can be stacked in multiple stages into a membrane cascade system 700 as illustrated in FIG. 7 to achieve a higher enrichment level. The membrane cascade system 700 uses the enriched stream 120 from the first compartment 104 of the previous stage 702-1 as the feed stream 110 of the second compartment 106 of the next stage 702-2, as shown in the figure, and so on.

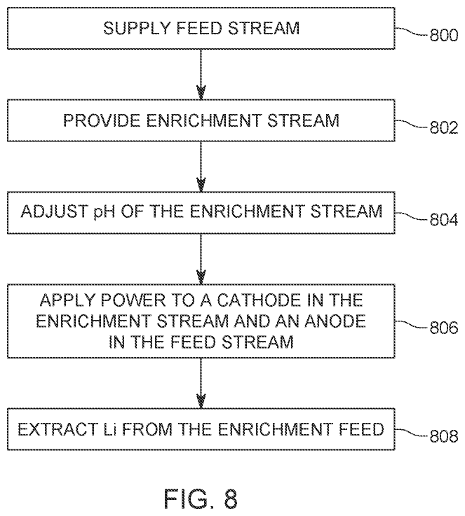

A brine of Li (Red Sea water) having a concentration of about 0.21 ppm (feed stream) was used with the cell 500 shown in FIG. 5 to enrich the Li concentration. More specifically and as shown in FIG. 8, the enrichment method starts in step 800 by supplying the feed stream 110 to the second compartment 106, in which the anode 107 is located. In step 802, the enrichment stream 120 is provided to the first compartment 104, in which the cathode 105 is located. While the feed stream 110 contains 0.21 ppm Li atoms, the original enrichment stream 120 can contain any amount of Li atoms. In step 804, the pH of the enrichment stream 120 is adjusted to be in a desired range, for example, 4.5 to 7.0. This is achieved by introducing an acid 140 (e.g., polyprotic or weak acids) into the stream, for example, directly into the first compartment 104, at the port 144. In one application, the controller 170 automatically measures the pH in the first compartment 104, with a sensor 171, and controls the amount of acid 140 released from the container 142 for achieving the target pH. Next, in step 806, the controller 170 instructs the power supply 109 to apply a voltage between the anode 107 and the cathode 105 to trigger the oxidative electrochemical reaction on the anode and a reductive electrochemical reaction on the cathode. The redox electrochemical reactions on the anode and cathode drives the lithium ions 150 from the feed stream 110, through the lithium selective membrane 108, to enrich in the enrichment stream 120, while the transport of the other ions present in the seawater is substantially blocked because of the glass-type dense and thin LLTO membrane. Then, in step 808, a part of the enrichment feed is taken away from the cell 500 and traditional processes of extracting the Li atoms are applied to extract the Li.

In this regard, the inventors note that U.S. Pat. No. 9,932,653 has discussed a similar lithium enrichment process (see FIG. 3 in this patent), which is described at column 4, line 60 to column 5, line 4, as not being successful because “the selectivity for Li ion 50 is not high.” In other words, the process illustrated in FIG. 3 of this patent is indicated to not be efficient because the Li ions are hydrated as they flow from the electrode to the membrane through the solution. To overcome this problem, the authors in the U.S. Pat. No. 9,932,653 have proposed to place the electrodes directly on the membrane, as shown in their FIG. 1, which is described at column 5, lines 9-15, as being successful, as “a high [of the Li ions] is obtained.” The inventors found that the process shown in FIG. 3 of the U.S. Pat. No. 9,932,653 is not efficient because of the characteristics of their membrane, . the lack of pH control of the feed stream. By using the (optional glass-type) dense and thin membrane discussed above and controlling the pH of the feed stream, the present inventors have discovered that the process discussed with regard to FIG. 8 is very efficient, being able to use ppb amounts of Li atom in the feed stream and still enriching the enrichment stream, which was not achieved by any known process or system in the field. This unexpected result is due to the dense and/or thin aspects of the LLTO membrane 108.

An optional step for the method illustrated in FIG. 8 is creating a third compartment to accommodate the anode electrode, as illustrated in FIG. 4. The third compartment is separated from the second compartment by an anion exchange membrane and may be filled with a NaCl solution to facilitate the release of chlorine gas. In an additional optional step, a Pt-Ru coated hollow fiber cathode may be used and CO₂ is introduced from an inner channel of the electrode to blow out into the first compartment, as illustrated in FIG. 5. In yet another optional step, that may be combined or not with the previous optional steps, a fourth membrane may be used to separate the cathode, as illustrated in FIG. 6. In another optional step, two or more cells may be connected in series, as illustrated in FIG. 7, to use the enrichment feed from a previous cell as the feed stream in the next cell, so that a concentration of the Li in the ultimate enrichment stream is increased. For example, for a 5-stage system, the inventors have obtained 9,000 ppm Li with a Li/Mg selectivity larger than 45 million, starting with an original feed stream having only 0.21 ppm Li atoms.

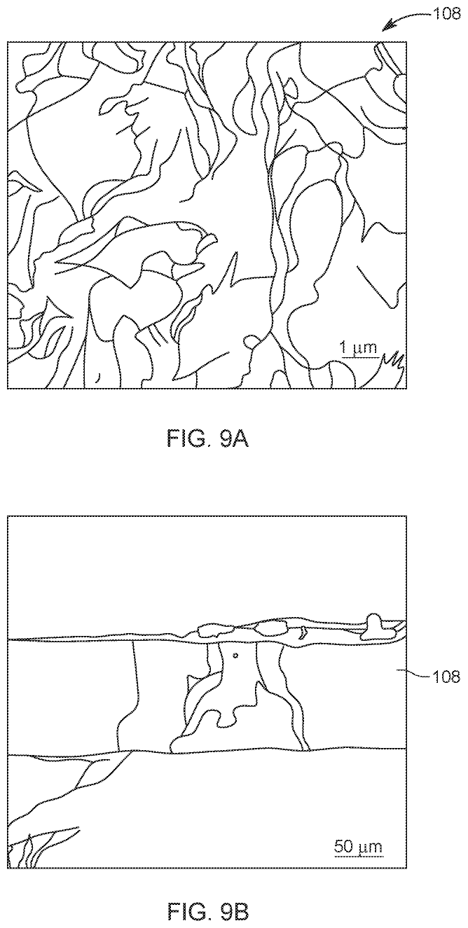

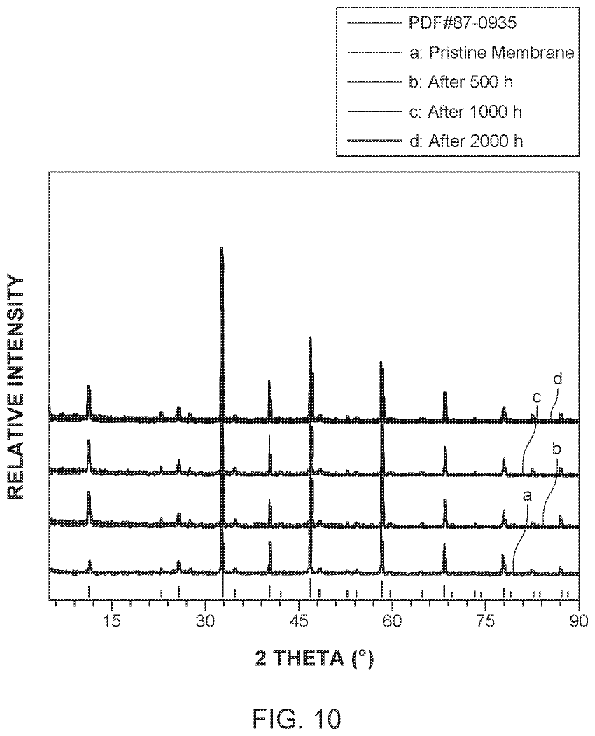

An example of making the (optional glass-type) dense and thin LLTO membrane 108 is now discussed. LLTO nanoparticles were first prepared using a sol-gel process following the chemical formula of Li0.33La_{0.56}TiO₃. Stoichiometric LiNO₃ and La(NO₃)₃ were dissolved in 25% aqueous citric acid whereby 18 equivalents citric acid were employed compared to that of LiNO₃. Subsequently, a stoichiometric quantity of titanium (IV) butoxide was added dropwise to the mixture under intense stirring (e.g., 1000 rpm), and the mixture was heated to 100° C. to obtain a homogenous solution prior to drying under continuous stirring at 150° C. The mole ratio of LiNO₃, La(NO₃)₃, titanium(IV) butoxide and citric acid in the final solution was 0.363:0.57:1.00:6.53. The obtained solid was sintered at 600° C. for 4 h and at 1050° C. for 20 h under air with both heating and cooling rates of 2° C. min⁻¹. The resulting white LLTO powder was sequentially ball-milled at 300 rpm for 12 h to obtain nanoparticles of about 200 nm in diameter. The LLTO nanoparticles were pelleted into disks with a diameter of 22 mm and a thickness of 70 μm and then sintered at 1050° C. for 4 h to release CO2 and NON, and further melted at 1275° C. for 8 h to reach a molten state to form the glass-type dense and thin LLTO membranes as shown in FIGS. 9A and 9B. The heating and cooling rates of the sintering process were set to 2° C. min⁻¹. During the sintering process, about 10% of the LiNO₃ was vaporized. Hence, the final chemical formula of the LLTO membrane was Li_{0.33}La_{0.57}TiO₃ as determined from the elemental analysis. The high magnification SEM images shown in FIGS. 9A and 9B indicate that the membrane 108's surface is smooth, with no grain boundaries. A thickness of the LLTO membrane is below 80 μm, more specifically about 60 μm. In one embodiment, the inventors found that an LLTO membrane 108 having a thickness of about 55 μm produced the unexpected results discussed herein. The membrane preparation process was controlled to yield a thickness about 10 times thinner than those reported in literature, which is one of the factors that allowed achieving a high Li⁺ permeance in the cells discussed above. The LLTO structure is confirmed by X-ray powder diffraction measurements, as shown in FIG. 10, where all the reflective peaks matched with the standard LLTO pattern. A mechanical test showed that the membrane had a stress of 110 MPa and a ductility of 0.066%, which indicates that the membrane is hard but brittle.

The copper hollow fibers 505 were prepared through a nonsolvent induced phase separation method followed by a high temperature sintering process. Copper powder (99%, about 1 mm particle size) was mixed with polysulfone (PSE), polyvinylpyrrolidone (MW about 10 000), and N-methylpyrrolidone (NMP, 99.5%) at a weight ratio of 64.4:6.2:1.5:27.9 to form a homogenous dope solution, which was then spun through a tube-in-orifice spinneret. The obtained hollow fibers were sintered at 600° C. for 3 h under air and then reduced in an atmosphere of hydrogen/argon (volume ratio=2:8) at 650° C. for 6 h. The Pt/Ru catalyst (50% on Kejenblack) was wetted with deionized water and then mixed with Nafion® solution (12.5% in dimethylformamide) in a weight ratio of 7:3. The Pt/Ru:Nafion mixture was sprayed on the copper hollow fiber surface at a level of 2.0 mg cm^{-2 .}

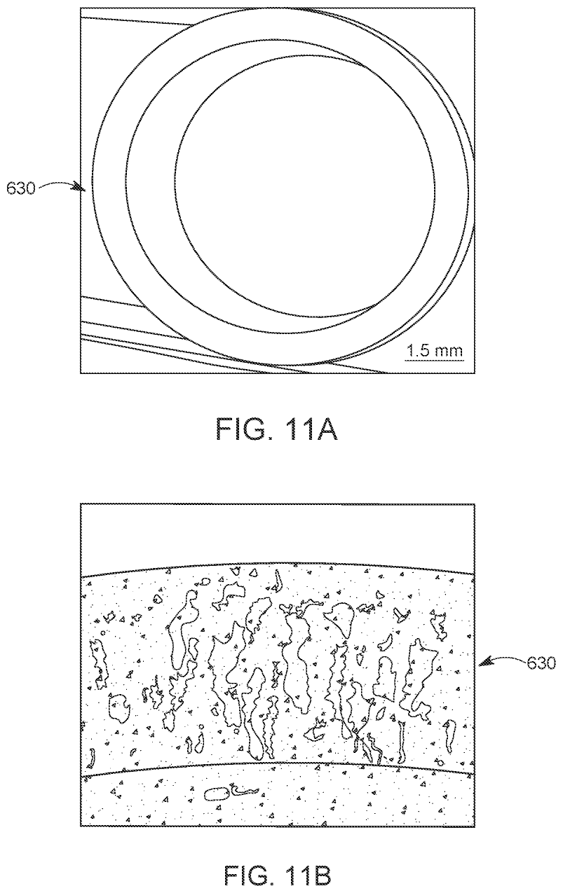

In one experiment that used the cell 700 with 5 stages, the LLTO membrane 108 (membrane area=2.01 cm²) and an AEM membrane 420 (membrane area=2.01 cm², Fumasep FAA-3-20, FuelCellStore, USA) were assembled into each of the cell 702-I and sealed by an O-ring. The solution volume circulated as the feed stream was 25 L for the first stage, and 2.5 L for the remainder of the stages. The solution volumes at the cathode and anode compartments were fixed at 2.5 and 25 ml in all stages, respectively. A catalytic Pt-Ru carbonic cloth gas diffusion electrode (FuelCellStore, USA) was used as the anode, and the Pt-Ru coated copper hollow fiber element 630 (see FIGS. 11A and 11B) was used as the cathode 505. The copper hollow fiber cathode 505 was connected to a CO₂ gas cylinder at a controlled CO₂ flow rate of 6.0 ml/min. Concentrated H₃PO₄ was further used as the auxiliary solution 140 to control the pH of the enrichment stream 120, between 4.5 and 7.0. The released Cl₂ was adsorbed by CH₂Cl₂ solution to avoid air contamination, while hydrogen was collected by a gas sampling bag. A constant voltage of 3.25 V was applied through a potentiostat.

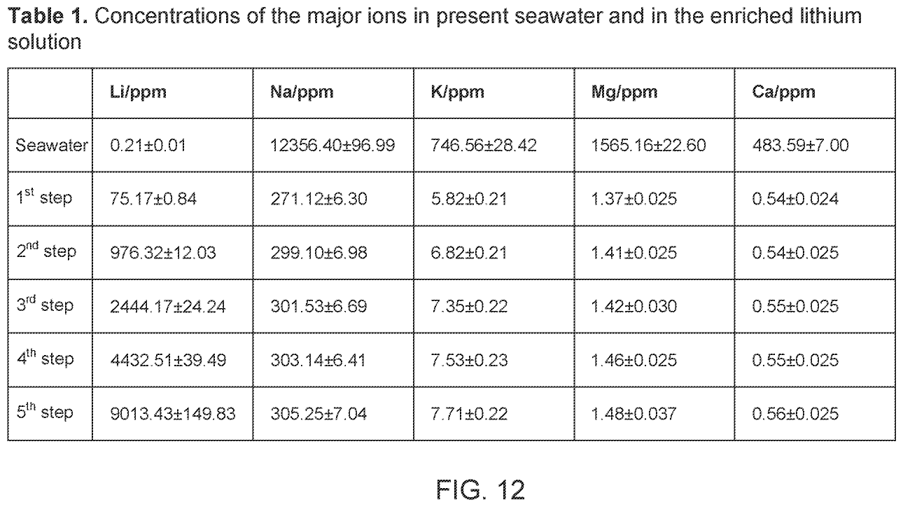

In the first stage, Red Sea water was used as the feed stream 110 and deionised water was used as the initial enrichment stream 120. In the 2^{nd} to 5^{th} stages, the enriched lithium solution from the previous stage was used as the feed and the initial enrichment streams. The operation time of each stage was fixed at 74,500 s. Table 1 in FIG. 12 lists the concentrations of the major ions in the seawater after each stage. With the exception of lithium, which was continuously enriched from the seawater level (0.21 ppm) to about 9,000 ppm in the last stage, all other ions exhibited significantly reduced concentrations and remained almost constant after the 2^{nd} stage. After the 5^{th} stage, a nominal Li/Mg selectivity of more than 45 million were achieved, which indicate the high efficiency of the cells discussed herein.

The nominal Li/Mg selectivity β was calculated by the following equation:

$$β = ( \frac{{C}_{Li , 5 th}}{{C}_{Li , sw}} ) / ( \frac{{C}_{Mg , 5 th}}{{C}_{Mg , sw}} ) ,$$

where C_{Li,5th}, C_{Mg,56th}, C_{Li,sw}, and C_{Mg,sw} are the mole concentrations of Li⁺ and Mg²⁺ in the 5^{th} enriched stream and 1^{st} seawater stream, respectively. The selectivity for a single stage can be calculated by the same formula, but the values for the 5^{th} stage are replaced by those for the 1^{st} stage.

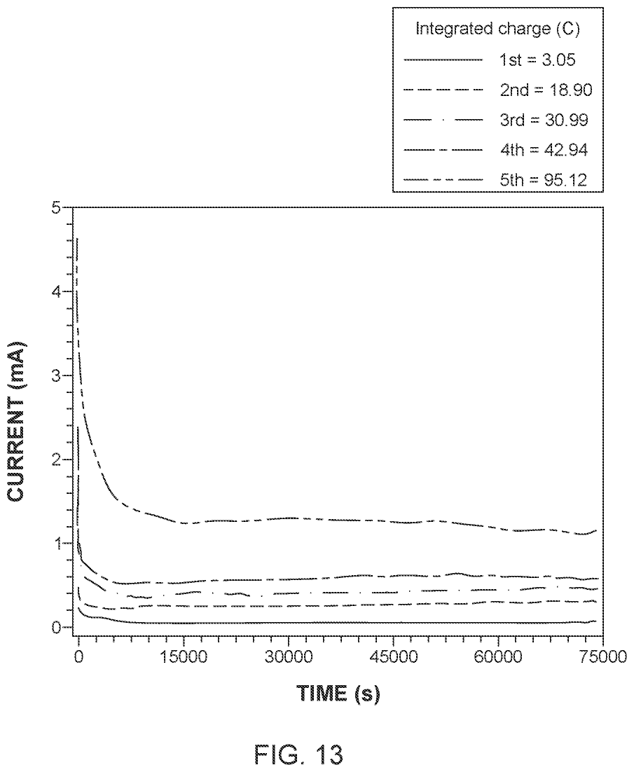

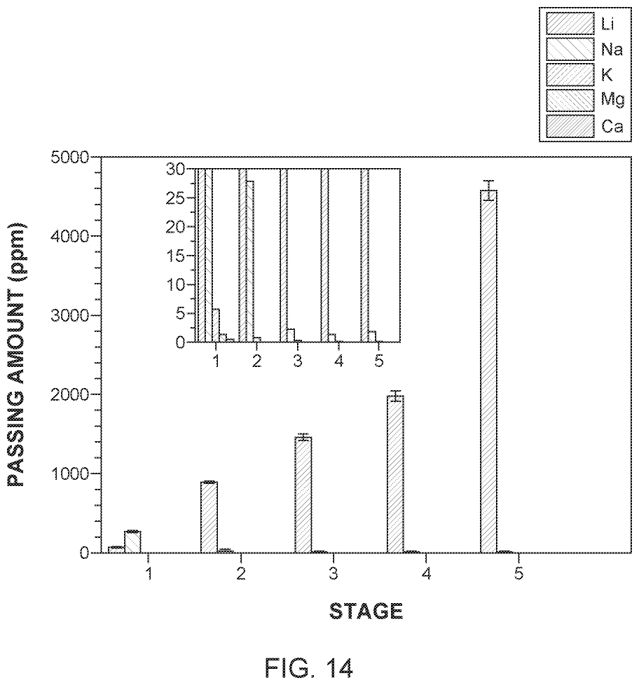

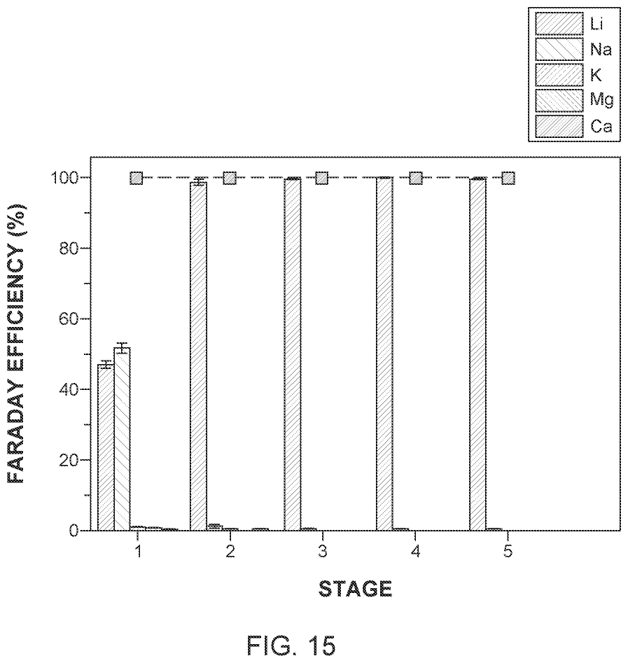

FIG. 13 shows the current recorded at each stage over time, whereby it is apparent that the current remains relatively stable after a sharp surge in the initial stage, which is due to the adsorption of ions onto the electrode and the membrane. Only in stage 5 did the current decrease slightly over time. The steady-state current increased with the lithium concentration in the feed stream. FIG. 14 shows the number of ions passing through the membrane at each stage. The amount of Li⁺ accelerates from the 1^{st} to the 5^{th} stages, which confirms the increasing transport rate with the feed concentration. For other ions, only in the first stage there are substantial amount of Na⁺ of about 300 ppm passing through the membrane, all others were almost completely blocked. FIG. 15 shows that the total Faradaic efficiencies of all stages were close to 100%. In the first stage, about 47.06% of electric energy was used to transport lithium, while in the remainder of the stages almost 100% of the electric energy was used for the lithium migration. Based on these data, the total amount of electricity required to enrich 1 kg lithium from seawater to 9,000 ppm in five stages was estimated to be 76.34 kWh. Simultaneously, 0.876 kg H₂ and 31.12 kg Cl₂ were collected from the cathode and the anode, respectively. Taking the US electricity price of US$ 0.065/kWh into consideration, the total electricity cost for this process is approximately US$ 5.0. In addition, based on the 2020 prices of hydrogen and Cl₂ (i.e., US$ 2.5-8.0/kg and US$ 0.15/kg, respectively), the side-product value can reach approximately US$ 6.9-11.7, which can well compensate for the total energy cost. These unexpected results, i.e., high electrical efficiency to move the Li ions across the membrane 108, low price that is fully compensated by the by-products, are due to the (optional glass-type) dense and thin LLTO membrane used in the cells. In addition, it is also noted that the total concentration of other salts after the first stage is less than 500 ppm, which implies that after lithium harvest, the remaining water can be treated as freshwater. Hence, the process also has a potential to integrate with seawater desalination to further enhance its economic viability.

It is further noted that the total energy consumption is proportional to the number of stages. However, the stable current curve shown in FIG. 13 implies that extending the processing time at each stage will render it possible to enrich the lithium concentration to a greater extent, and thereby reduce the number of stages. This approach will be conducted at the penalty of a low production rate. The exceptionally slow transport rate in the first stage (see FIG. 13) indicates that the lithium enrichment in the first stage is a parameter that need to be adjusted for the energy-productivity trade-off. In this experiment, the duration of the first stage was determined based on the product purity, which requires the Mg concentration to be about 2.0 ppm. Hence, the first stage was stopped when the Mg²⁺ concentration in the enrichment stream reached about 1.5 ppm, as shown in Table 1. Under these conditions, the lithium concentration reached about 75 ppm. Thus, in one embodiment, the duration of the first stage is determined based on the Mg concentration in the enrichment stream. For this implementation, the processor 170 may be connected to a sensor that determines the Mg concentration in the enrichment stream.

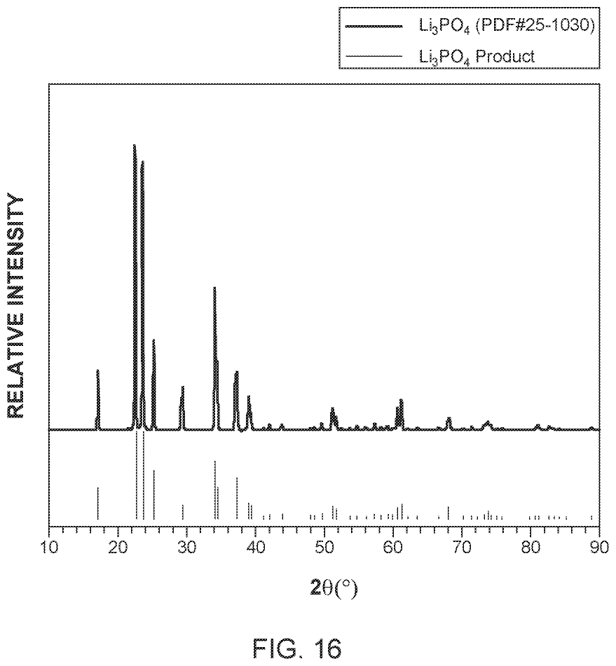

Lithium could be precipitated out in the form of Li₃PO₄ from the 5^{th} stage enrichment stream by adjusting the pH to 12.25 using a 10.0 M NaOH solution. The sediment was separated by centrifugation, rinsed using deionised water, and then dried under vacuum. The collected white powder was characterised by XRD spectroscopy, as shown in FIG. 16, whereby the XRD pattern fit well with the standard pattern of Li₃PO₄ (PDF#25-1030) without any impurity signals being detected. Further quantitative elemental analyses showed that the purity of Li₃PO₄ is 99.94±0.03%, and the Na, K, Mg, and Ca contents of the product are 194.53±7.80, 0.99±0.02, 25.16±0.83, and 17.18±0.57 ppm, respectively, which meet the requirements for the lithium battery-grade purity.

The embodiments discussed herein describe a continuous electrical pumping membrane process, which successfully enriched lithium from seawater samples of the Red Sea. The success of the embodiments described above depends on the thin and (glass-type) dense LLTO membrane, which provides efficient separation between lithium and other interfering ions, in addition to a high lithium permeation rate. In one application, the separation of the anode compartment from the feed compartment by an anion exchange membrane and the use of a saturated NaCl solution in the anode compartment allow the release of Cl₂. This is necessary to prevent the dissolution of the highly soluble Cl₂ in the large volume of the feed stream. In yet another application, the use of a CO₂ and phosphate buffer solution stabilizes the pH and prolongs the lifetime of the membrane. Indeed, it was found that the LLTO membrane could be used for 200 h with a negligible decay in performance. Also, the use of a metallic copper hollow fibre enhanced the faradaic efficiency to about 100% in all stages. The combination of enrichment with the conventional precipitation method makes the process less sensitive to the interference of soluble ions. The energy consumption is greatly reduced. Cost analysis showed that the value of the by-product could well overcome the energy cost.

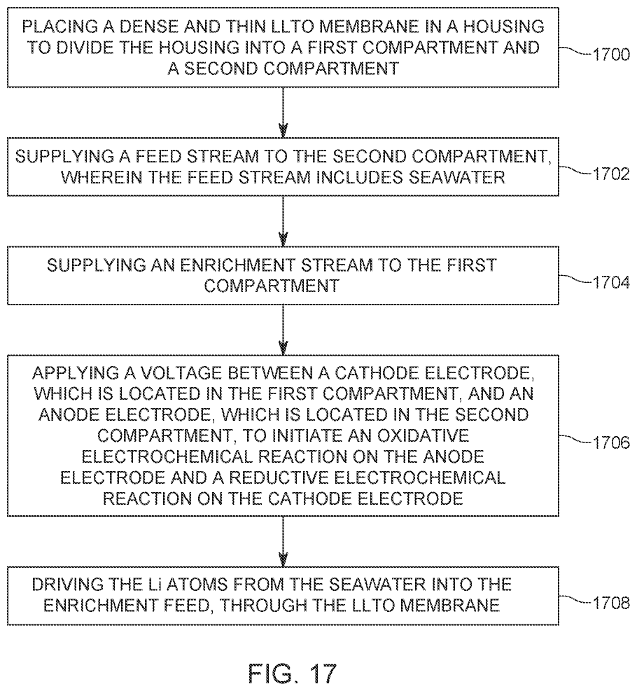

A method for enhancing Li in one of the cells discussed above is now discussed with regard to FIG. 17. The method includes a step 1700 of placing a (optional glass-type) dense and thin LLTO membrane in a housing to divide the housing into a first compartment and a second compartment, a step 1702 of supplying a feed stream to the second compartment, wherein the feed stream includes seawater, a step 1704 of supplying an enrichment stream to the first compartment, a step 1706 of applying a voltage between a cathode electrode, which is located in the first compartment, and an anode electrode, which is located in the second compartment, to initiate an oxidative electrochemical reaction on the anode electrode and a reductive electrochemical reaction on the cathode electrode, and a step 1708 of driving the Li atoms from the seawater into the enrichment feed, through the LLTO membrane.

The method may further include a step of injecting an acid into the enrichment stream to maintain a pH between 4.5 and 7.0, and/or a step of adding a first anion exchange membrane to the second compartment to form a third compartment so that the anode electrode is located in the third compartment, and/or a step of supplying an anode stream to the third compartment, the anode stream being different from the feed stream and the enrichment stream, the anode stream being configured to not absorb chlorine generated by the anode electrode so that the chlorine is captured at a port formed in the third compartment. In one application, the cathode electrode is made of copper hollow fibers coated with Pt-Ru and the copper hollow fibers form an inner channel that receives CO₂ from outside the housing.

The method may further include a step of adding a second anion exchange membrane to the first compartment to form a fourth compartment so that the cathode electrode is located in the fourth compartment, and/or a step of supplying a cathode stream to the fourth compartment, the cathode stream being different from the feed stream and the enrichment stream, and/or a step of adding copper hollow fibers located in the first compartment, wherein the copper hollow fibers are coated with Pt-Ru and the copper hollow fibers form an inner channel, and/or a step of supplying CO₂ to the inner channel, from outside the housing, and releasing the CO₂ within the enrichment stream.

The disclosed embodiments provide a system and method for enriching lithium from a marine brine having a very low lithium concentration. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] U.S. Pat. No. 6,764,584 B2

[2] U.S. Pat. No. 4,636,295

[3] U.S. Pat. No. 9,932,653 B2

[4] U.S. Pat. No. 10,689,766 B2

1. A cell for enhancing a lithium (Li) concentration in a stream, the cell comprising:
a housing;
a dense lithium selective membrane located in the housing and dividing the housing into a first compartment and a second compartment;
a cathode electrode located in the first compartment;
an anode electrode located in the second compartment;
a first piping circuit fluidly connected to the second compartment and configured to supply a feed stream to the second compartment;
a second piping circuit fluidly connected to the first compartment and configured to circulate an enrichment stream through the first compartment; and
a power source configured to apply a voltage between the cathode electrode and the anode electrode to initiate an oxidative electrochemical reaction on the anode electrode and a reductive electrochemical reaction on the cathode electrode, wherein the dense lithium selective membrane has a thickness less than 400 μm.

2. The cell of claim 1, wherein the dense, lithium selective membrane is a glass-type LiₓLa_{2/3-x/3}TiO₃ (LLTO) membrane, where x is from 0.23 to 0.67.

3. The cell of claim 1, further comprising:
a port fluidly connected to the first compartment to inject an acid into the enrichment stream to maintain a pH between 4.5 and 7.0.

4. The cell of claim 3, further comprising:
a first anion exchange membrane placed in the second compartment to form a third compartment so that the anode electrode is located in the third compartment.

5. The cell of claim 4, wherein an anode stream is supplied to the third compartment, the anode stream being different from the feed stream and the enrichment stream, the anode stream being configured to not absorb chlorine generated by the anode electrode so that the chlorine is captured at a port formed in the third compartment.

6. The cell of claim 4, wherein the cathode electrode is made of copper hollow fibers. Pt-Ru.

7. The cell of claim 6, wherein the copper hollow fibers are coated with

8. The cell of claim 6, wherein the copper hollow fibers form an inner channel that receives CO₂ from outside the housing.

9. The cell of claim 4, further comprising:
a second anion exchange membrane placed in the first compartment to form a fourth compartment so that the cathode electrode is located in the fourth compartment.

10. The cell of claim 9, wherein a cathode stream is supplied to the fourth compartment, the cathode stream being different from the feed stream and the enrichment stream.

11. The cell of claim 9, further comprising:
copper hollow fibers located in the first compartment.

12. The cell of claim 11, wherein the copper hollow fibers are coated with Pt-Ru.

13. The cell of claim 11, wherein the copper hollow fibers form an inner channel that receives CO₂ from outside the housing and release the CO₂ within the enrichment stream.

14. A multi-stage cell for enhancing a lithium (Li) concentration in a stream, the multi-stage cell comprising:
plural cells connected in series to each other,
each cell of the plural cells including:
a housing;
a dense lithium selective membrane located in the housing and dividing the housing into a first compartment and a second compartment;
a cathode electrode located in the first compartment;
an anode electrode located in the second compartment;
a first piping circuit fluidly connected to the second compartment and configured to supply a feed stream to the second compartment;
a second piping circuit fluidly connected to the first compartment and configured to circulate an enrichment stream through the first compartment; and
a power source configured to apply a voltage between the cathode electrode and the anode electrode to initiate an oxidative electrochemical reaction on the anode electrode and a reductive electrochemical reaction on the cathode electrode,
wherein the dense, lithium selective membrane has a thickness less than 400 μm, and
wherein the enrichment stream from a previous cell is the feed stream of a current cell.

15. A method for enhancing a lithium (Li) concentration in a cell, the method comprising:
placing a dense lithium selective membrane in a housing to divide the housing into a first compartment and a second compartment;
supplying a feed stream to the second compartment, wherein the feed stream includes seawater;
supplying an enrichment stream to the first compartment;
applying a voltage between a cathode electrode, which is located in the first compartment, and an anode electrodes, which is located in the second compartment, to initiate an oxidative electrochemical reaction on the anode electrode and a reductive electrochemical reaction on the cathode electrode; and
driving the Li atoms from the seawater into the enrichment feed, through the dense lithium selective membrane, wherein the dense, lithium selective membrane has a thickness less than 400 μm.

16. The method of claim 15, wherein the dense, lithium selective membrane is a glass-type LiₓLa_{2/3-x/3}TiO₃ (LLTO) membrane, where x is from 0.23 to 0.67.

17. The method of claim 15, further comprising:
injecting an acid into the enrichment stream to maintain a pH between 4.5 and 7.0.

18. The method of claim 15, further comprising:
adding a first anion exchange membrane to the second compartment to form a third compartment so that the anode electrode is located in the third compartment.

19. The method of claim 18, further comprising:
supplying an anode stream to the third compartment, the anode stream being different from the feed stream and the enrichment stream, the anode stream being configured to not absorb chlorine generated by the anode electrode so that the chlorine is captured at a port formed in the third compartment.

20. The method of claim 18, wherein the cathode electrode is made of copper hollow fibers coated with Pt-Ru and the copper hollow fibers form an inner channel that receives CO₂ from outside the housing.

21. The method of claim 18, further comprising:
adding a second anion exchange membrane to the first compartment to form a fourth compartment so that the cathode electrode is located in the fourth compartment.

22. The method of claim 21, further comprising:
supplying a cathode stream to the fourth compartment, the cathode stream being different from the feed stream and the enrichment stream.

23. The method of claim 19, further comprising:
adding copper hollow fibers to the first compartment, wherein the copper hollow fibers are coated with Pt-Ru and the copper hollow fibers form an inner channel; and
supplying CO₂ to the inner channel, from outside the housing, and releasing the CO₂ within the enrichment stream.
